(19) United States
(12) Patent Application Publication
(10) Pub. No.: US 2008/0099255 A1
(43) Pub. Date: May 1, 2008

(54) Device to significantly expand the range of an electric vehicle

(76) Inventor: Richard Neil Heisler, Brighton, CO (US)

Correspondence Address: Richard Heisler, 437 Nth 8th Ave., Brighton, CO, 80601, US

(21) Appl. No.: 11/796,981

(22) Filed: Apr. 30, 2007

Related U.S. Application Data
(60) Provisional application No. 60/746,139, filed on May 1, 2006.

(51) Int. Cl. B60L 8/00

(52) U.S. Cl. 180/65.1

(57) ABSTRACT

The invention will allow a vehicle that uses electric power for its primary drive system to have a more useful range.

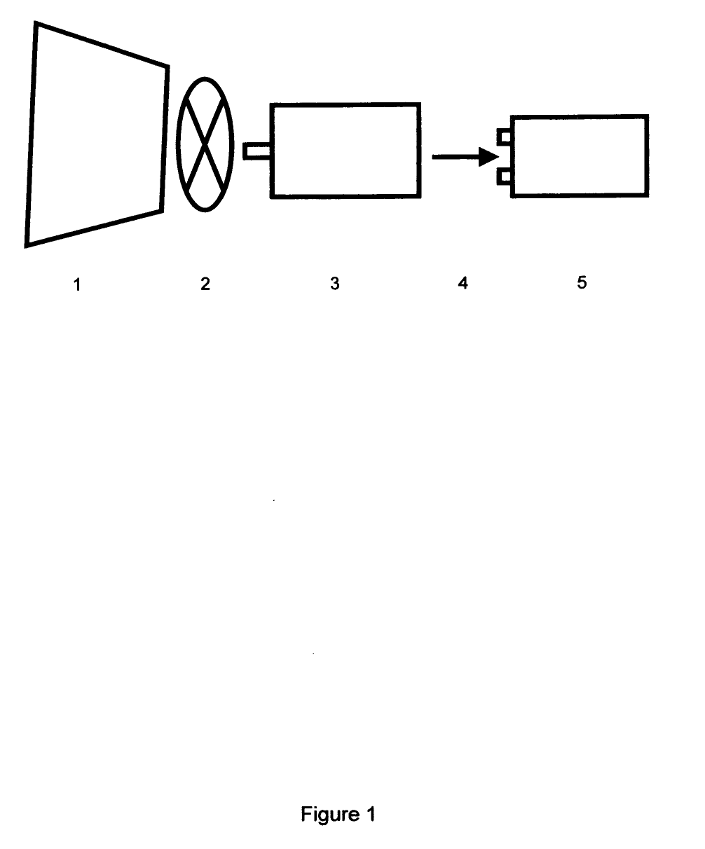

The present invention relates to a device that significantly expands the range of an electric vehicle. The invention is comprised of an electric motor (FIG. 1, part 3) with a device attached to it that will effectively turn the motor (FIG. 1, part 2) is placed into the wind stream of a vehicle. Ideally, this would be in a protected area such as under the hood of said vehicle. It may or may not have a shroud or funnel to focus, or increase, the wind speed exerted on the device (FIG. 1, part 1).

The electric motor (FIG. 1, part 3) is turned by a blade in the wind stream of a vehicle (FIG. 1, part 2). The invention uses this motion to create an electric current. For example, if a vehicle is driving down the street at 35 MPH then the wind speed behind the grill is 35 MPH. This force turning the electric motor generates electricity that is then sent back to the batteries (FIG. 1, part 5). The amount of electricity created will depend on a number of variables. Some of these may include but are not limited to motors and batteries used as well as wind speed. This device could significantly increase the operable range of electric vehicles.

The preferred embodiment of the invention would be as a wind hybrid including all of the parts of the diagram. However, the device could be used in different ways, such as alternate mounting locations on the vehicle. Also, it may use single or multiple blades (FIG. 1, part 2), with or without a collecting device (FIG. 1, part 1) or even just wired differently (FIG. 1, part 4).

The invention could be used to produce a charge in any machine that moves at a sufficient speed to produce a charge.

1. Electric vehicle will be able to travel greater distance.

2. Decreases the need for existing fossil fuel driven vehicles.

3. Reliance on oil and other fossil fuels could be diminished.

4. A zero emissions vehicle would reduce amount of pollution.
